(19) United States
(12) Patent Application Publication
(10) Pub. No.: US 2020/0047691 A1
(43) Pub. Date: Feb. 13, 2020

(54) TRIM PART FOR A VEHICLE INTERIOR

(71) Applicant: AUDI AG, Ingolstadt (DE)

(72) Inventors: Matthias WUNDERLICH, Ingolstadt (DE); Arya BHATTACHARYA, Erlenbach (DE); Richard LUIJKX, Ingolstadt (DE)

(73) Assignee: AUDI AG, Ingolstadt (DE)

(21) Appl. No.: 16/534,322

(22) Filed: Aug. 7, 2019

(30) Foreign Application Priority Data
Aug. 7, 2018 (DE) 10 2018 213 224.0

(51) Int. Cl. B60R 13/02; B32B 27/12; B32B 21/08; B32B 21/14

(52) U.S. Cl. CPC B60R 13/02; B32B 27/12; B32B 2250/03; B32B 21/14; B32B 2605/003; B32B 21/08

(57) ABSTRACT

A trim part for a vehicle interior, in particular a visible side decorative strip or panel, with a brittle visible side cover layer that is susceptible to breaking in the event of a crash, in particular in the event of a head impact, such as a wood veneer or a carbon layer, which is injection-molded with a plastic carrier layer, said trim part being loaded in the event of a crash to deflection to breakage of the component. According to exemplary embodiments of the invention, in order to increase the breaking strength in the event of a crash, a fabric layer made from a textile material is integrated in the layer structure of the trim part.

### FIELD

The invention relates to a trim part for a vehicle interior and to a method for producing a trim part.

### BACKGROUND

A decorative strip with a visible side wood veneer can be installed as an example in a potential head impact area in the instrument panel. In this case, increased demands are placed on the crash safety of the decorative strip. On the one hand, the decorative strip must be made sufficiently resilient in the event of an impact-related bending stress. On the other hand, it must be ensured that in the event of a collision-induced component fracture of the decorative strip that break segments of the decorative strip do not form sharp edges or splinter into the vehicle interior.

A generic trim part has a visible side, component-brittle cover layer, such as a wood veneer or a carbon layer, which is susceptible to breakage under crash load. The cover layer is injection-molded with a plastic carrier layer. In the event of a crash, that is, for example, in the event of a head impact of the vehicle occupant, the trim part is loaded to deflection.

In the prior art, such a trim part has a layer structure consisting of a plurality of veneer layers with a metal layer (for example made of aluminum) integrated therein and a plastic carrier layer. The plurality of veneer layers reduces component distortion. The integrated metal layer causes a significant increase in component stiffness in the event of a crash.

The layer structure known from the prior art is disadvantageous in that the majority of veneer layers, together with the aluminum layer, leads to a large component thickness. This may result in package problems in tight space conditions. In addition, the integration of a metal layer in the multi-layer structure is costly.

DE 10 2008 009 766 A1 discloses a material layer with adhesion promoters and a method for producing such a material layer. FR 2 991 904 A1 and FR 30 366 70 A disclose further trim parts for the vehicle interior.

### SUMMARY

The object of the invention is to provide a trim part for a vehicle interior, which can be built in a space-saving manner compared to the prior art and can be produced at a reduced cost.

At least one fabric layer is integrated in the material structure (layer structure) of the trim part to increase the breaking strength/flexural strength of the trim part. The fabric layer is made of a textile material or a semi-finished textile fiber product, which significantly increases the component stiffness or the bending strength of the trim part in the event of a crash, even omitting the additional metal layer known from the above prior art.

In a technical implementation, the trim panel can be realized as a thin-layer application in which the layer structure of the trim part is not constructed from a large variety of veneer layers, but rather only constructed in exactly three layers, that is with the visible side cover layer (especially a wood veneer), the plastic carrier layer and the fabric layer. In this way, an overall reduced component thickness of the trim part is achieved, whereby the trim part can be used even in confined spaces.

The textile fabric layer preferably has a warp and weft thread system in which the warp threads and the weft threads cross at nodal points. In addition, reinforcement fibers can be integrated in the fabric layer, for example made of glass, carbon, aramid, basalt or the like.

In a first embodiment, the textile fabric layer may be arranged in the layer structure between the cover layer and the plastic carrier layer. In the production of the trim part the fabric layer can thus be inserted together with the cover layer in a mold cavity of an injection mold. In this case the fabric layer may be a dry semi-finished fabric, that is to say pre-impregnated or soaked with plastic. Subsequently, the cover layer together with the semi-finished fabric product can be injection-molded with the plastic material of the plastic carrier layer in an injection mold. In this case the textile fabric layer is embedded directly in the plastic material of the plastic carrier layer.

In the above layer structure, the brittle cover layer is in direct contact with the textile fabric layer, as a result of which surface irregularities in the fabric layer can optionally be found as optically disadvantageous fiber marks on the visible side of the finished trim part. Such surface irregularities arise at the nodal points of the warp and weft thread system, where the warp and weft threads cross each other.

To increase the surface quality of the trim part, it is preferred according to a second embodiment, when the cover layer is injection-molded without interposition of the fabric layer directly with the plastic material of the plastic carrier layer. In this case, the textile fabric layer can be mounted force-transmittingly to the plastic carrier layer on the back side of the trim part facing away from the cover layer. The mounting of the fabric layer at the back side of the trim part can be done by welding or by heat staking. As an example, plastic pins can be formed on the back side of the trim part on the plastic carrier layer, which in each case project through recesses of the fabric layer and which have a heat-staking enlarged element head. Said element head engages behind the edge region of the opening of the respective fabric layer recess in order to connect the fabric layer force-transmittingly to the plastic carrier layer.

Using the above-mentioned three-layer structure, consisting of the cover layer, the plastic carrier layer and the fabric layer, the trim part can be produced with extremely low component thickness. In a first embodiment, the above-mentioned reduced-thickness layer structure may extend completely over the entire trim part.

Alternatively, the trim part may have at least one section with reduced component thickness which is realized with the above thickness-reduced layer structure. In contrast, the trim part can have a comparatively space-consuming trim part section without such a fabric layer. In order to still provide a sufficient bending stiffness in the space-consuming trim part section, with omitted fabric layer, the layer thickness of the plastic carrier layer can be increased, such as by forming stiffening ribs or the like.

### BRIEF DESCRIPTION OF THE FIGURES

Hereinafter, exemplary embodiments of the invention are described with reference to the accompanying figures.

FIG. 1 shows an indicated instrument panel with built-in decorative strip in a roughly schematic side view;

FIG. 2 shows a layer structure of the decorative strip in a sectional view;

FIG. 3 shows an exploded view consisting of a visible side wood veneer and a textile fabric layer;

FIG. 4 shows a second exemplary embodiment of the trim part in a view corresponding to FIG. 2;

FIG. 5 shows a decorative strip according to a third exemplary embodiment in a perspective view.

### DETAILED DESCRIPTION

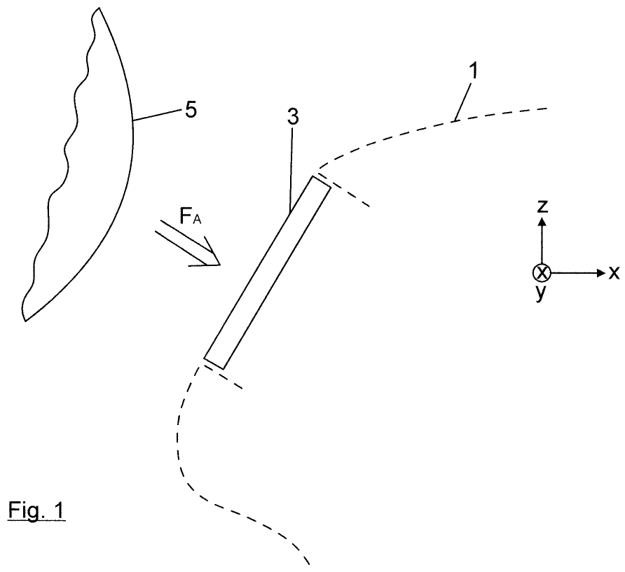

In FIG. 1, the contour 1 of an instrument panel of a motor vehicle is indicated in a roughly schematic representation, in which a decorative strip 3 is installed. Decorative strip 3 extends by way of example strip-shaped in the vehicle transverse direction y in the passenger area of instrument panel 1. As is further apparent from FIG. 1, the instrument panel 1 is in a test facility with a head impactor 5, by means of which a head impact test is performed, in which a crash-induced head impact is simulated on decorative strip 3 of instrument panel 1.

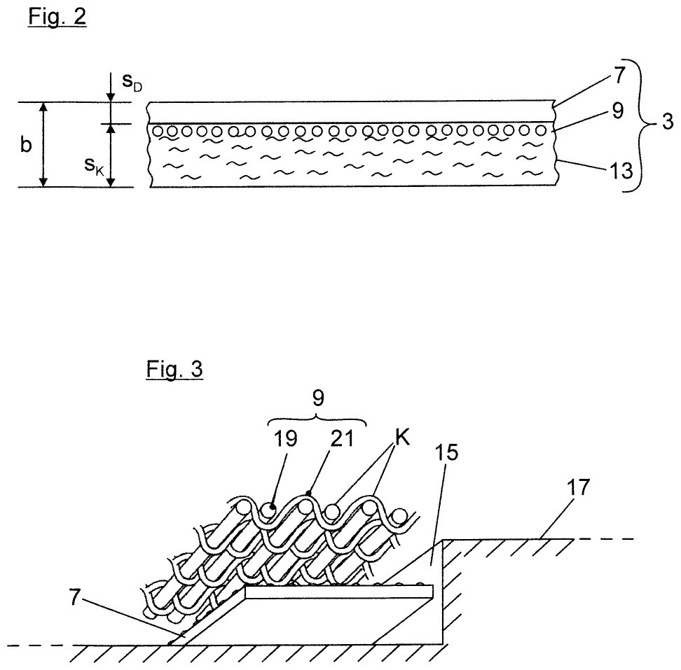

FIG. 2 indicates a layer structure of decorative strip 3. Accordingly, decorative strip 3 has a brittle wood veneer on its visible side as cover layer 7, which in a crash-induced head impact is susceptible to breakage. To increase the breaking strength of the wood veneer 7, decorative strip 3 has the layer structure indicated in FIG. 2. Accordingly, decorative strip 3 is comprised exactly of three layers which are the already mentioned visible side layer 7 made of a wood veneer, a textile fabric layer 9 and a plastic carrier layer 13. In FIG. 2, the textile fabric layer 9 is arranged between the visible side layer 7 and the plastic carrier layer 13. The cover layer 7 made of wood veneer may have, by way of example, a layer thickness s_{D} of 0.35 mm, while a layer thickness s_{K} of the plastic carrier layer 13 is, for example, 3.5 mm. This results in a component thickness b of the order of 4 mm.

In FIG. 3, cover layer 7 (that is, the wood veneer) is preformed together with fabric layer 9 and placed in a mold cavity 15 of an injection mold 17 to produce decorative strip 3. Thereafter, the mold cavity 15 is closed and an injection molding process carried out in which covering layer 7 is injection-molded with the plastic material of the plastic carrier layer 13 under pressure and heat. In this way, fabric layer 9 is embedded directly in the plastic material of plastic carrier layer 13.

As is further apparent from FIG. 3, textile fabric layer 9 has a warp and weft thread system with warp threads 19 and weft threads 21. The warp and weft threads 19, 21 may be exemplified as reinforcing fibers of glass, carbon, aramid, basalt or the like. According to FIG. 3, warp and weft threads 19 cross at nodal points K, which results in surface irregularities with elevations/depressions. These can form optically disadvantageous fiber markings on the visible side of finished trim part 3.

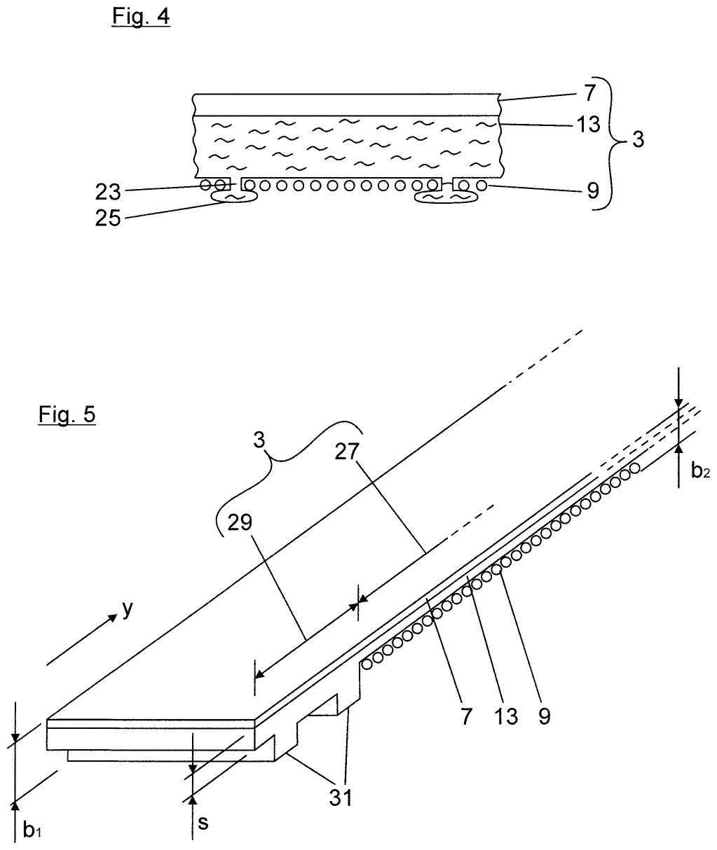

In order to increase the surface quality, cover layer 7 may optionally be injection-molded directly with the plastic material of plastic carrier layer 13 without interposing fabric layer 9, as shown in FIG. 4. In this case, fabric layer (9) is force-transmittingly mounted to plastic carrier layer (13) on the back side of the trim part facing away from cover layer 7. For mounting to plastic carrier layer 13 plastic pins 23 are formed on the plastic carrier layer 13, which project through corresponding recesses of fabric layer 9 and have an element head 25 which has been enlarged by means of heat-staking. The plastic pins 23 engage—with their enlarged element heads 25—the edge region of the opening of the fabric layer recesses, whereby fabric layer 9 is connected force-transmittingly to plastic carrier layer 13.

In FIG. 5, decorative strip 3 is shown in a perspective view alone in a further exemplary embodiment. Accordingly, in a direction of extension y, decorative strip 3 has a space-consuming section 29 with increased component thickness b₁, and adjacent a space-reduced section 27 with a smaller component thickness b₁. The space-reduced trim part section 27 has the thickness-reduced layer structure consisting of cover layer (wood veneer) 7, plastic carrier layer 13 and a fabric layer blank 9. In this way, in spite of reduced component thickness b₂ in the space-reduced trim part section 27, a sufficiently large bending stiffness can be provided. In contrast, the space-consuming trim part section 29 is realized without textile fabric layer 9. Instead, fabric layer 9 is omitted in the space-consuming trim part section 29. Instead, in the space-consuming trim part section 29, the breaking strength (bending strength) is increased by increasing the layer thickness s of plastic carrier layer 13 to form stiffening ribs 31.

1. A trim part for a vehicle interior, comprising:
a decorative strip or panel, with a visible side cover layer, that is susceptible to breaking in the event of a crash, such as a wood veneer or a carbon layer, which is injection-molded with a plastic carrier layer, said trim part being loaded in the event of a crash to deflection to breakage of the component, wherein in order to increase the breaking strength in the event of a crash a fabric layer made from a textile material is integrated in the layer structure of the trim part.

2. The trim part according to claim 1, wherein the layer structure of the trim part is comprised of exactly three layers, which are the visible side cover layer, the plastic carrier layer and the fabric layer.

3. The trim part according to claim 1, wherein the fabric layer is arranged in a layer structure between the cover layer and the plastic carrier layer.

4. The trim part according to claim 3, wherein for the preparation of the trim part the fabric layer is inserted as a dry tissue semi-finished product together with the cover layer in a mold cavity of an injection mold, and thereafter, in an injection molding process, the cover layer is injection-molded with plastic material of the plastic carrier layer, and/or in that the fabric layer is embedded in the plastic material of the plastic carrier layer.

5. The trim part according to claim 1, wherein the cover layer is injection-molded without interposition of the fabric layer directly with the plastic material of the plastic carrier layer, and in that the fabric layer is force-transmittingly mounted to the plastic carrier layer on the back side of the trim part facing away from the cover layer.

6. The trim part according to claim 5, wherein the mounting of the fabric layer is done by welding or by heat staking, and/or in that at least one plastic pin is formed in particular on the back side of the trim part on the plastic carrier layer, which projects through a recess of the fabric layer and which has an element head enlarged by heat-staking, which engages behind the edge region of the opening of the fabric layer recess.

7. The trim part according to claim 1, wherein the trim part has at least one space-consuming section with increased component thickness and a space-reduced section of low component thickness, and in that the fabric layer is integrated in the space-reduced trim part section to increase the breaking strength, and/or in that the fabric layer is omitted in the space-consuming trim part section, and instead the layer thickness of the plastic carrier layer is increased to increase the breaking strength by forming stiffening ribs.

8. The trim part according to claim 1, wherein the textile fabric layer has a warp and weft thread system in which reinforcing fibers are integrated, such as made of glass, carbon, aramid, basalt or the like.

9. The trim part according to claim 2, wherein the fabric layer is arranged in a layer structure between the cover layer and the plastic carrier layer.

10. The trim part according to claim 2, wherein the cover layer is injection-molded without interposition of the fabric layer directly with the plastic material of the plastic carrier layer, and in that the fabric layer is force-transmittingly mounted to the plastic carrier layer on the back side of the trim part facing away from the cover layer.

11. The trim part according to claim 2, wherein the trim part has at least one space-consuming section with increased component thickness and a space-reduced section of low component thickness, and in that the fabric layer is integrated in the space-reduced trim part section to increase the breaking strength, and/or in that the fabric layer is omitted in the space-consuming trim part section, and instead the layer thickness of the plastic carrier layer is increased to increase the breaking strength by forming stiffening ribs.

12. The trim part according to claim 3, wherein the trim part has at least one space-consuming section with increased component thickness and a space-reduced section of low component thickness, and in that the fabric layer is integrated in the space-reduced trim part section to increase the breaking strength, and/or in that the fabric layer is omitted in the space-consuming trim part section, and instead the layer thickness of the plastic carrier layer is increased to increase the breaking strength by forming stiffening ribs.

13. The trim part according to claim 4, wherein the trim part has at least one space-consuming section with increased component thickness and a space-reduced section of low component thickness, and in that the fabric layer is integrated in the space-reduced trim part section to increase the breaking strength, and/or in that the fabric layer is omitted in the space-consuming trim part section, and instead the layer thickness of the plastic carrier layer is increased to increase the breaking strength by forming stiffening ribs.

14. The trim part according to claim 5, wherein the trim part has at least one space-consuming section with increased component thickness and a space-reduced section of low component thickness, and in that the fabric layer is integrated in the space-reduced trim part section to increase the breaking strength, and/or in that the fabric layer is omitted in the space-consuming trim part section, and instead the layer thickness of the plastic carrier layer is increased to increase the breaking strength by forming stiffening ribs.

15. The trim part according to claim 6, wherein the trim part has at least one space-consuming section with increased component thickness and a space-reduced section of low component thickness, and in that the fabric layer is integrated in the space-reduced trim part section to increase the breaking strength, and/or in that the fabric layer is omitted in the space-consuming trim part section, and instead the layer thickness of the plastic carrier layer is increased to increase the breaking strength by forming stiffening ribs.

16. The trim part according to claim 2, wherein the textile fabric layer has a warp and weft thread system in which reinforcing fibers are integrated, such as made of glass, carbon, aramid, basalt or the like.

17. The trim part according to claim 3, wherein the textile fabric layer has a warp and weft thread system in which reinforcing fibers are integrated, such as made of glass, carbon, aramid, basalt or the like.

18. The trim part according to claim 4, wherein the textile fabric layer has a warp and weft thread system in which reinforcing fibers are integrated, such as made of glass, carbon, aramid, basalt or the like.

19. The trim part according to claim 5, wherein the textile fabric layer has a warp and weft thread system in which reinforcing fibers are integrated, such as made of glass, carbon, aramid, basalt or the like.

20. The trim part according to claim 6, wherein the textile fabric layer has a warp and weft thread system in which reinforcing fibers are integrated, such as made of glass, carbon, aramid, basalt or the like.
